(19) United States
(12) Patent Application Publication
(10) Pub. No.: US 2025/0111979 A1
(43) Pub. Date: Apr. 3, 2025

(54) INDUCTOR FOR SUPPRESSING COMMON MODE (CM) AND DIFFERENTIAL MODE (DM) NOISE

(71) Applicant: Telefonaktiebolaget LM Ericsson (publ), Stockholm (SE)

(72) Inventors: Chong Zhao, Stockholm (SE); Jingxuan Hu, Beijing (CN)

(21) Appl. No.: 18/725,765

(22) PCT Filed: Jan. 5, 2022
(86) PCT No.: PCT/CN2022/070300

§ 371 Date: Jun. 29, 2024

(51) Int. Cl. H01F 17/04; H01F 3/10; H01F 17/00; H01F 27/28

(52) U.S. Cl. CPC H01F 17/043; H01F 3/10; H01F 27/2823; H01F 2003/106; H01F 2017/0093

(57) ABSTRACT

The present disclosure provides an inductor for suppressing noise in a pair of a first signal and a second signal. The inductor comprises: a first core; a second core adjoined to the first core; a first coil wound around at least a first portion of the first core; a second coil wound around at least a second portion of the second core; and a third core adjoined to the first core and/or the second core and disposed between the first coil and the second coil, wherein the inductor is operable to attenuate both CM noise and DM noise in the first signal and the second signal that pass through the first coil and the second coil, respectively.

### TECHNICAL FIELD

The present disclosure is related to the field of electronic component, and in particular, to an inductor for suppressing common mode (CM) noise and differential mode (DM) noise.

### BACKGROUND

This section introduces aspects that may facilitate better understanding of the disclosure. Accordingly, the statements of this section are to be read in this light and are not to be understood as admissions about what is in the prior art or what is not in the prior art.

In electronics, a choke is typically an inductor used to block higher-frequency while passing direct current (DC) and lower-frequencies of alternating current (AC) in an electrical circuit. A choke usually consists of a coil of insulated wire often wound around a magnetic core, although some consist of a doughnut-shaped “bead” of ferrite material strung on a wire. The choke's impedance increases with frequency. Its low electrical resistance passes both AC and DC with little power loss, but its reactance limits the amount of AC passed.

A CM choke, where two coils are wound around a single core, is useful for suppression of electromagnetic interference (EMI) and radio frequency interference (RFI) from power supply lines and for prevention of malfunctioning of power electronics device. It passes differential currents (equal but opposite), while blocking common-mode currents. The magnetic flux produced by differential-mode (DM) currents in the core tends to cancel each other out since the windings are negative coupled. Thus, the choke presents little inductance or impedance to DM currents. The CM currents, however, see a high impedance because of the combined inductance of the positive coupled windings. CM chokes are commonly used in industrial, electrical and telecommunications applications to remove or decrease noise and related electromagnetic interference.

### SUMMARY

According to an aspect of the present disclosure, an inductor for suppressing noise in a pair of a first signal and a second signal is provided. The inductor comprises: a first core; a second core adjoined to the first core; a first coil wound around at least a first portion of the first core; a second coil wound around at least a second portion of the second core; and a third core adjoined to the first core and/or the second core and disposed between the first coil and the second coil, wherein the inductor is operable to attenuate both CM noise and DM noise in the first signal and the second signal that pass through the first coil and the second coil, respectively.

In some embodiments, the third core is made of a material having a lower magnetic permeability than that of the first core and/or the second core and a higher magnetic permeability than that of air. In some embodiments, the first core and/or the second core are made of R10K material, wherein the third core is made of PC95 material.

In some embodiments, at least one of the first portion and the second portion has a shape of cylinder. In some embodiments, the first portion is adjoined to the second portion by their end faces of the cylinders. In some embodiments, the first portion is separated from the second portion by an air gap. In some embodiments, the first portion is separated from the second portion by at least a third portion of the third core. In some embodiments, the first core and the second core are identical to each other. In some embodiments, the first portion and the second portion are integrally formed. In some embodiments, the third core partially or completely surrounds at least a part of the first portion and/or at least a part of the second portion. In some embodiments, at least one of the first core and the second core is an EP type core. In some embodiments, the first core, the second core, or the combination thereof has a portion surrounds the third core. In some embodiments, the inductor further comprises: a bottom frame on which the first core and the second core are supported, and through which one or more terminals of the first coil and/or the second coil are exposed.

In some embodiments, the first coil has a first terminal and a second terminal, and the second coil has a third terminal and a fourth terminal, wherein the first coil and the second coil have winding directions and terminal definitions such that a magnetic field created by the first signal and a magnetic field created by the second signal are offset to each other when the first and second signals pass through the first and second coils, respectively.

In some embodiments, the first terminal is an input terminal and the second terminal is an output terminal and closer to the third core than the first terminal, wherein the third terminal is an input terminal and the fourth terminal is an output terminal and closer to the third core than the third terminal, wherein the first coil has one of a left-handed winding direction and a right-handed winding direction between the first terminal and the second terminal, wherein the second coil has the same winding direction between the third terminal and the fourth terminal as that of the first coil.

In some embodiments, the first terminal is an output terminal and the second terminal is an input terminal and closer to the third core than the first terminal, wherein the third terminal is an output terminal and the fourth terminal is an input terminal and closer to the third core than the third terminal, wherein the first coil has one of a left-handed winding direction and a right-handed winding direction between the first terminal and the second terminal, wherein the second coil has the same winding direction between the third terminal and the fourth terminal as that of the first coil.

In some embodiments, the first terminal is an input terminal and the second terminal is an output terminal and closer to the third core than the first terminal, wherein the third terminal is an output terminal and the fourth terminal is an input terminal and closer to the third core than the third terminal, wherein the first coil has one of a left-handed winding direction and a right-handed winding direction between the first terminal and the second terminal, wherein the second coil has the other of the left-handed winding direction and the right-handed winding direction between the third terminal and the fourth terminal.

In some embodiments, the first terminal is an output terminal and the second terminal is an input terminal and closer to the third core than the first terminal, wherein the third terminal is an input terminal and the fourth terminal is an output terminal and closer to the third core than the third terminal, wherein the first coil has one of a left-handed winding direction and a right-handed winding direction between the first terminal and the second terminal, wherein the second coil has the other of the left-handed winding direction and the right-handed winding direction between the third terminal and the fourth terminal.

In some embodiments, the number of turns of wire in at least one of the first and second coils is 4.5. In some embodiments, the inductor has a dimension of (22.0 mm±0.6 mm)*(21.4 mm±0.6 mm)*(22.5 mm±0.3 mm). In some embodiments, at least one of the first and second coils is made of a flat wire. In some embodiments, at least one of the first and second coils is formed by a helical winding method.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating the operational principle of an exemplary common mode choke in the related art.

FIG. 2 is a schematic diagram illustrating a part of an exemplary circuit in which an inductor according to an embodiment of the present disclosure may be applicable.

FIG. 3 shows (a) a front view, (b) a top view, (c) a right side view, and (d) a perspective view of an exemplary inductor according to an embodiment of the present disclosure.

FIG. 4A and FIG. 4B show (a) a perspective view, (b) an upside-down exploded view, and (c) a bottom view of an exemplary real inductor according to an embodiment of the present disclosure.

FIG. 5 shows (a) an upside-down perspective view of a half of an inductor and (b) a perspective view of one of the cores of the inductor according to an embodiment of the present disclosure.

FIG. 6A, FIG. 6B, and FIG. 6C are diagrams illustrating operational principles of exemplary inductors according to some embodiments of the present disclosure.

FIG. 7 shows product specifications of an exemplary inductor according to an embodiment of the present disclosure.

FIG. 8 shows product specifications of a core of an exemplary inductor according to an embodiment of the present disclosure.

FIG. 9 shows product specifications of a coil of an exemplary inductor according to an embodiment of the present disclosure.

FIG. 10 shows (a) a left side view, (b) a bottom view, (c) a front view, and (d) a perspective view of a middle core of an exemplary inductor according to an embodiment of the present disclosure.

FIG. 11 shows product specifications of a bottom frame of an exemplary inductor according to an embodiment of the present disclosure.

FIG. 12 and FIG. 13 show comparisons between simulation results for a conventional CMC and an inductor according to an embodiment of the present disclosure.

FIG. 14 shows some other exemplary middle cores of an inductor according to some other embodiments of the present disclosure.

FIG. 15A and FIG. 15B show various configurations of exemplary cores of an inductor according to another embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just means that there is an electrical or communicative connection between two elements and they can be connected either directly or indirectly, unless explicitly stated to the contrary.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

Of course, the present disclosure may be carried out in other specific ways than those herein set forth without departing from the scope and essential characteristics of the invention. One or more of the specific processes discussed below may be carried out in any communications transceiver comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the invention is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of Radio Frequency (RF) communication circuit, the present disclosure is not limited thereto.

Furthermore, relative terms, such as “lower”, “bottom”, “upper”, “top”, “left”, or “right,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Exemplary embodiments of the present disclosure are described herein with reference to cross-section illustrations that are schematic illustrations of idealized embodiments (and intermediate structures) of the present disclosure. As such, variations from the shapes of the illustrations as a result, for example, of manufacturing techniques and/or tolerances, may be expected. Thus, the disclosed example embodiments of the present disclosure should not be construed as limited to the particular shapes of regions illustrated herein unless expressly so defined herein, but are to include deviations in shapes that result, for example, from manufacturing. Thus, the regions illustrated in the figures are schematic in nature and their shapes are not intended to illustrate the actual shape of a region of a device and are not intended to limit the scope of the invention, unless expressly so defined herein.

Some terms used herein will be introduced below before some embodiments of the present disclosure are described.

Common Mode Choke (CMC): a CMC is an important component in Electromagnetic Interference (EMI)/Electromagnetic Compatibility (EMC) filter. A common mode choke is an electrical filter that blocks high frequency noise common to two or more data or power lines while allowing the desired DC or low-frequency signal to pass.

Leakage Inductance: leakage inductance can function as DM inductance in EMI filters.

Magnetic Integration: magnetic integration is a solution where two or more magnetic elements are combined into a single structure. By proper phasing of the windings and the placement of an air gap in a specific location in the flux path, integration allows more efficient use of the cross-sectional area of the transformer or inductor core, resulting in a reduced need for core material.

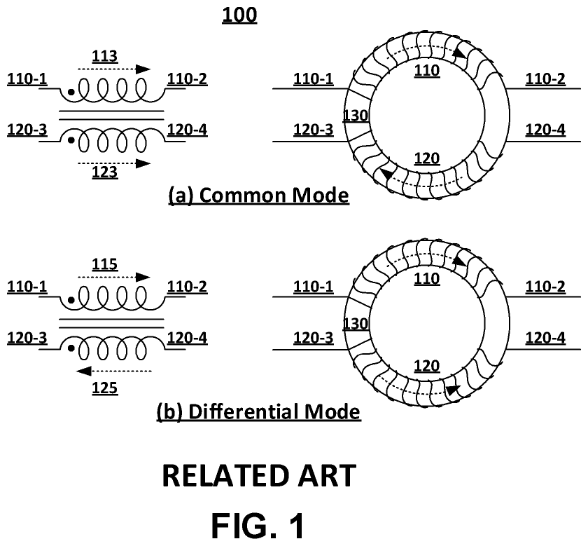

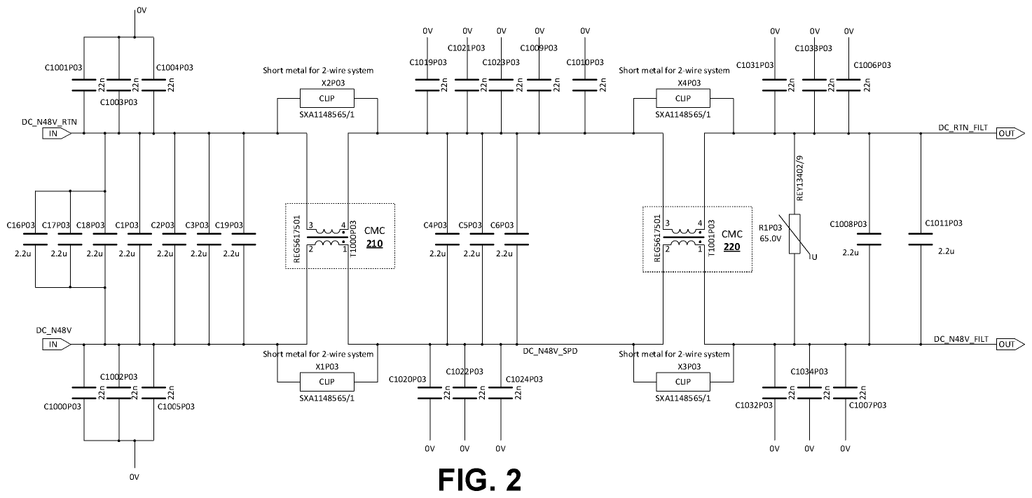

As mentioned above, a common mode choke may be used to suppress common mode components of a pair of signals with respect to the ground, such as noise. The description of the operational principle of a common mode choke will be given with reference to FIG. 1 below.

FIG. 1 is a diagram illustrating the operational principle of an exemplary common mode choke 100 in the related art. As shown in FIG. 1, the common mode choke 100 may comprise a toroid magnetic core (or sometimes “core” hereinafter) 130 and two coils 110 and 120 which are wound around the core 130. The coil 110 has two ends or terminals 110-1 and 110-2, and the coil 120 also has two ends or terminals 120-3 and 120-4, for signal inputs and/or outputs. Further, the coil 110 may have a winding direction different from or same as that of the coil 120, depending on the definition of the ends or terminals, or depending on how the ends or terminals of the coils 110 and 120 are used.

As shown in (b) normal or differential mode of FIG. 1, signal current travels on one line in one direction from the source (e.g. the end 110-1) to the load (e.g. the end 110-2), and in the opposite direction (e.g. from the end 120-4 to the end 120-3) on the return line that completes the circuit. Further, as shown in (a) common mode of FIG. 1, a CM noise current travels on both lines in the same direction (e.g. from the end 110-1 to the end 110-2 and from the end 120-3 to the end 120-4).

As mentioned above, in the case of (a) common mode, the common mode components of the currents or signals, which may be caused by the noise common to the ground, may have a same travelling direction, shown by the reference numerals 113 and 123 at the top left corner of FIG. 1, respectively. In such a case, as shown at the top right corner of FIG. 1, the magnetic fields caused by these two common mode components 113 and 123 may have a same direction as indicated by the arrows, and therefore are added to each other to create an increased overall magnetic field which in turn opposes the common mode components 113 and 123, according to the Coiling Right Hand Rule. In other words, the common mode components of the signals 113 and 123 will be suppressed by the common mode choke 100.

On the contrary, in the case of (b) differential mode, the differential mode components of the signals, which may be the original differential signals we desired, may have different travelling directions, shown by the differential mode components 115 and 125 at the bottom left corner of FIG. 1, respectively. In such a case, as shown at the bottom right corner of FIG. 1, the magnetic fields caused by these two differential mode components 115 and 125 have opposite directions as indicated by the arrows, and therefore are offset or cancelled out by each other to create a decreased or even cancelled magnetic field which does not suppress the differential mode components 115 and 125. In other words, the differential mode components of the signals 115 and 125 will not be suppressed by the common mode choke 100.

Therefore, in the common mode, currents in a group of lines travel in a same direction such that the combined magnetic flux adds to create an opposing field to block the noise, as illustrated by (a) common mode in FIG. 1. In the differential mode, the currents travel in opposite directions and the flux subtracts or cancels out such that the field does not oppose the normal mode signal, as illustrated by (b) differential mode in FIG. 1.

Please note some of CMCs are consist of a toroid core with two or more windings, for example, as that shown in FIG. 1, but the present disclosure is not limited thereto. In some other embodiments, other types of cores may be used, for example, as will be detailed below. In some embodiments, radio products may use an EI type CMC and/or a toroid CMC. In some other embodiments, an ERU type CMC may also be used. Further, as will be described below, an inductor having an EP type core may be used.

FIG. 2 is a schematic diagram illustrating a part of an exemplary circuit in which an inductor according to an embodiment of the present disclosure may be applicable. As shown in FIG. 2, two CMCs 210 and 220 may be used for CM noise suppression. In some embodiments, the two CMCs 210 and 220 may comprise EP type cores as mentioned above. With such CMCs, CM noise in the circuit may be suppressed as required. However, in a radio system or any other electrical system, there are both common mode noise and differential mode noise, and a CMC may only be used for suppressing CM noise while the DM noise cannot be suppressed. Therefore, additional inductors may be required to suppress the DM noise. For example, one or more inductors may be provided for suppressing DM noise.

However, there are several problems with this solution:
The CMCs 210 and 220 and additional inductors may occupy a very large space, for example, the largest CMC may have a volume of 13900.05 mm³;
EMC performance is not good enough for low frequency noise.

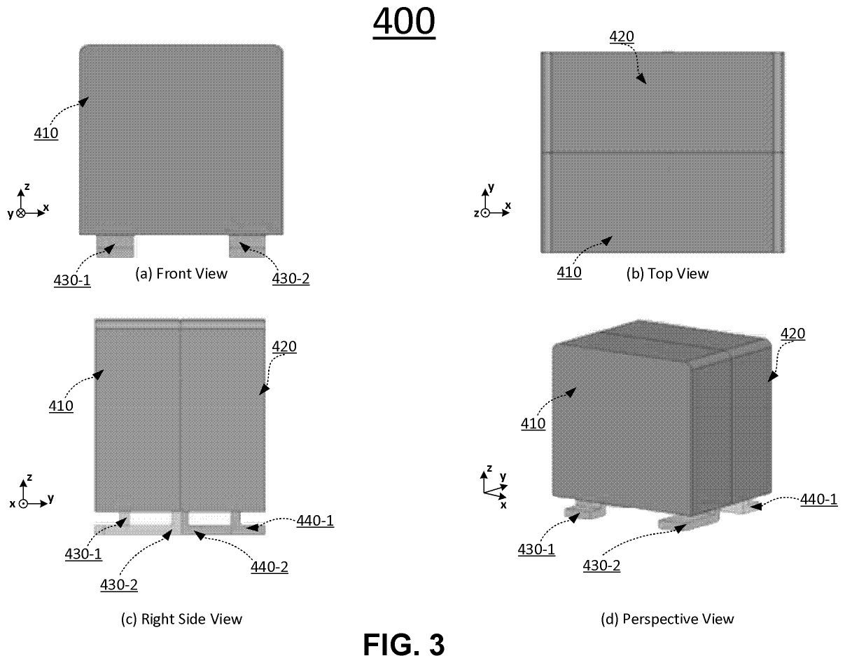

Therefore, to solve or at least partially alleviate the problems, an inductor according to some embodiments of the present disclosure is proposed. The description of the inductor will be given below with reference to FIG. 3 through FIG. 15B.

In some embodiments, one component of the inductor may have multiple functions. In some embodiments, a leakage inductance from a CMC may be used to improve its EMC performance, especially to improve suppression of the DM noise within the low frequency range. That is, the magnetic integration theory is used to extend the capability of a CMC to the field of DM noise suppression. In this regard, the improved CMC may also be referred to as an inductor for suppressing both CM and DM noises.

With the improved CMC or inductor for suppressing both CM and DM noises, a much better EMC performance may be achieved than a conventional CMC. Further, in a radio product, by replacing the conventional CMC with the inductor of the present disclosure, multiple input inductors at full bridge may be omitted while EMC requirements can still be met.

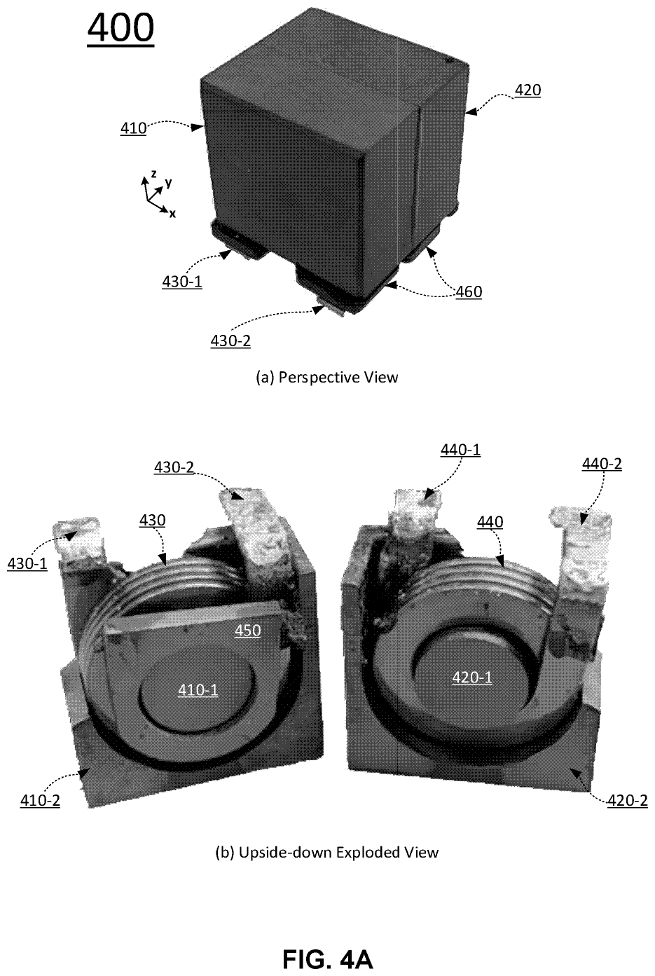

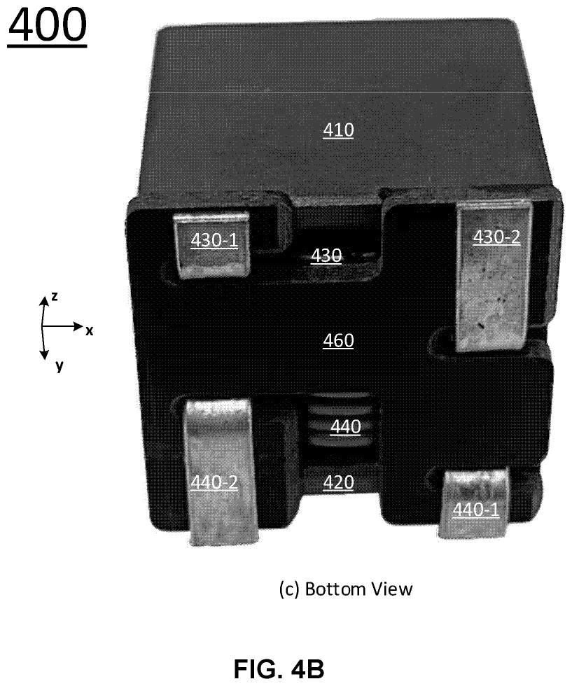

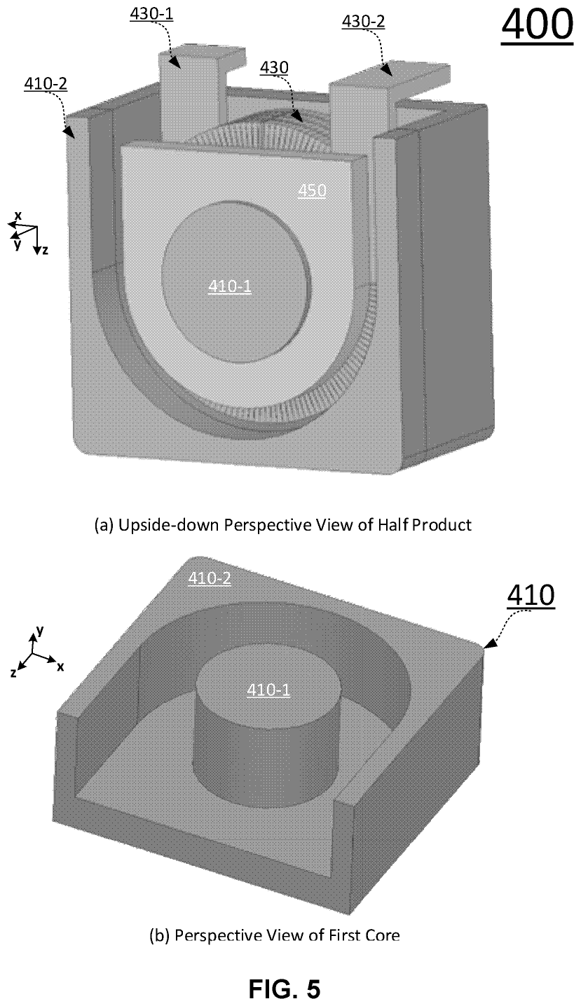

FIG. 3 shows (a) a front view, (b) a top view, (c) a right side view, and (d) a perspective view of an exemplary inductor according to an embodiment of the present disclosure. FIG. 4A and FIG. 4B show (a) a perspective view, (b) an upside-down exploded view, and (c) a bottom view of an exemplary real inductor according to an embodiment of the present disclosure. FIG. 5 shows (a) an upside down perspective view of a half of an inductor and (b) a perspective view of one of the cores of the inductor according to an embodiment of the present disclosure. The inductors shown in FIG. 3, FIG. 4A, FIG. 4B, and FIG. 5 may correspond to each other, and therefore the inductors will be collectively referred to as the inductor 400 hereinafter.

In some embodiments, the inductor 400 may be used for suppressing noise in a pair of a first signal and a second signal. For example, the first signal and the second signal may be a pair of differential signals to be filtered by the inductor 400. The inductor 400 may comprise a first core 410 and a second core 420, as clearly shown in (d) of FIG. 3 and (b) of FIG. 4A. The second core 420 may be adjoined to the first core 410 as shown in FIG. 3. In some other embodiments, the second core 420 is not adjoined to the first core 410 directly, but with another component interposed therebetween. In some embodiments, at least one of the first core 410 and the second core 420 may be an EP type core. In some embodiments, at least one of the first core 410 and the second core 420 may be an EP-21 core, as shown in (b) of FIG. 5.

As shown in (b) of FIG. 4A, the inductor 400 may further comprise a first coil 430 and a second coil 440. The first coil 430 may be wound around at least a first portion 410-1 of the first core 410. The second coil 440 may be wound around at least a second portion 420-1 of the second core 420.

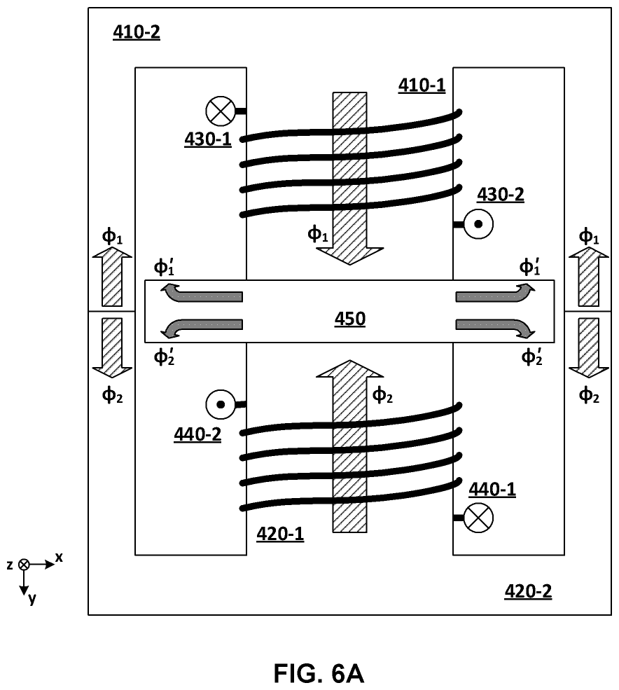

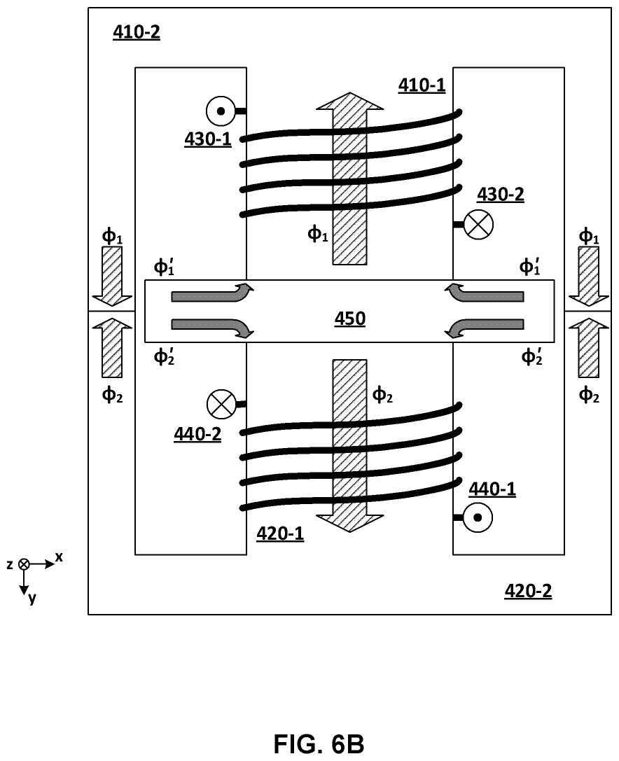

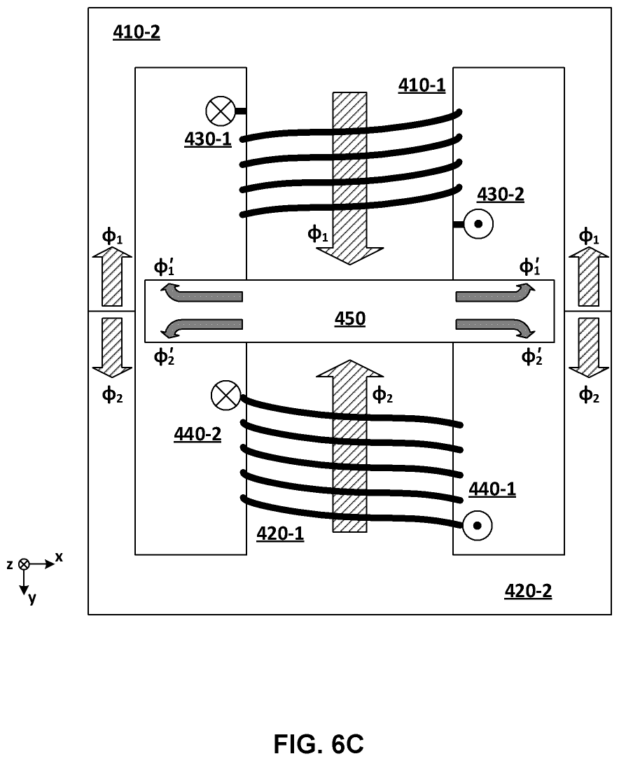

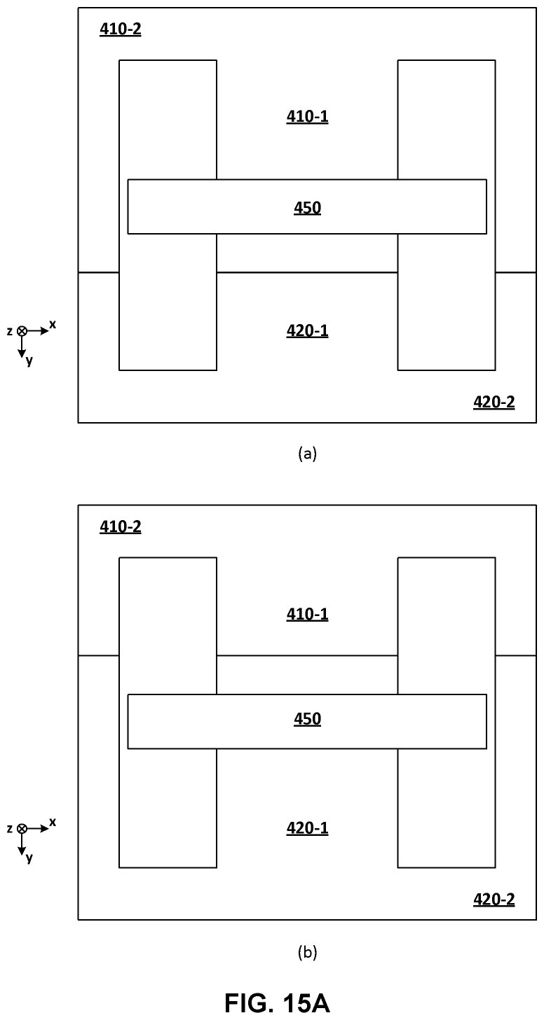

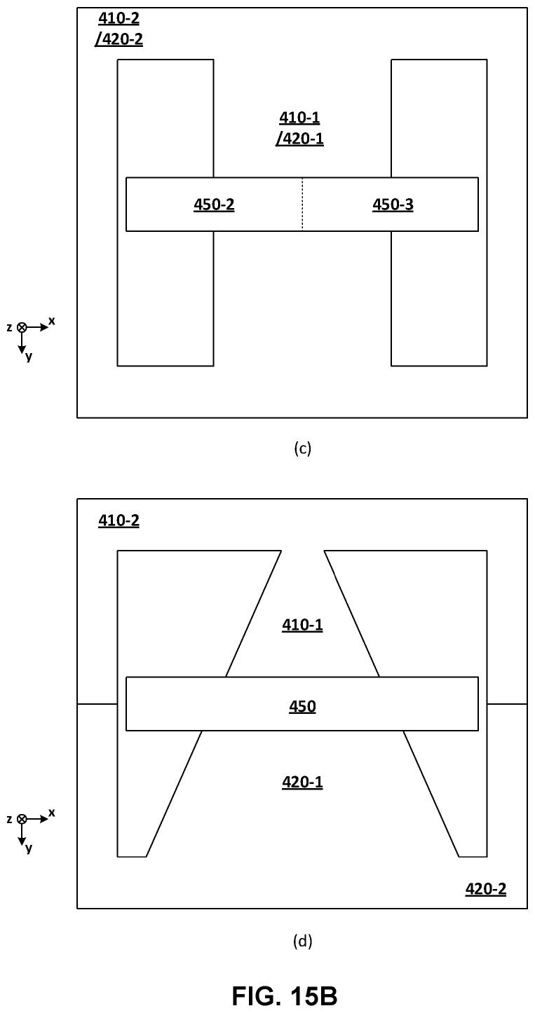

Further, the inductor 400 may further comprise a third core (or “middle core” as will be used sometimes below) 450. The third core 450 may be adjoined to the first core 410 and/or the second core 420, and may be disposed between the first coil 430 and the second coil 440. In some embodiments, the third core 450 may be adjoined to the first core 410 only, while not adjoined to the second core 420, for example, as shown in (a) of FIG. 15A. In some embodiments, the third core 450 may be adjoined to the second core 420 only, while not adjoined to the first core 410, for example, as shown in (b) of FIG. 15A. In some embodiments, the third core 450 may be adjoined to both of the first core 410 and the second core 420, for example, as shown in FIG. 6A through FIG. 6C.

Further the inductor 400 may be operable to attenuate both CM noise and DM noise in the first signal and the second signal that pass through the first coil 430 and the second coil 440, respectively.

In some embodiments, the third core 450 may be made of a material having a lower magnetic permeability than that of the first core 410 and/or the second core 420 and a higher magnetic permeability than that of air. In some embodiments, the first core 410 and/or the second core 420 may be made of R10K material, while the third core 450 may be made of PC95 material. In some embodiments, the first core 410 and/or the second core 420 may be made of R10K material with initial permeability around 10000.

In some embodiments, at least one of the first portion 410-1 and the second portion 420-1 may have a shape of cylinder, for example, as shown in FIG. 6A through FIG. 6C, FIG. 15A, and (c) of FIG. 15B. In some other embodiments, the first portion 410-1 and/or the second portion 420-1 may have a different shape than the cylinder, for example, as shown in (d) of FIG. 15B. In some other embodiments, the shape of the first and/or second portions 410-1/420-1 may be a regular shape, such as cylinder, cone, pyramid, cubic, frustum, or the like, or an irregular shape.

In some embodiments, the first portion 410-1 may be adjoined to the second portion 420-1 by their end faces of the cylinders, for example, as explicitly shown in FIG. 15A and implicitly shown in FIG. 4A or FIG. 6A through 6C. In some embodiments, the first portion 410-1 may be separated from the second portion 420-1 by an air gap. In some embodiments, the first portion 410-1 may be partially adjoined to the second portion 420-1 and partially separated from the second portion 420-1 by an air gap. The air gap may be formed unintentionally, for example, due to a process limit or manufacturing error.

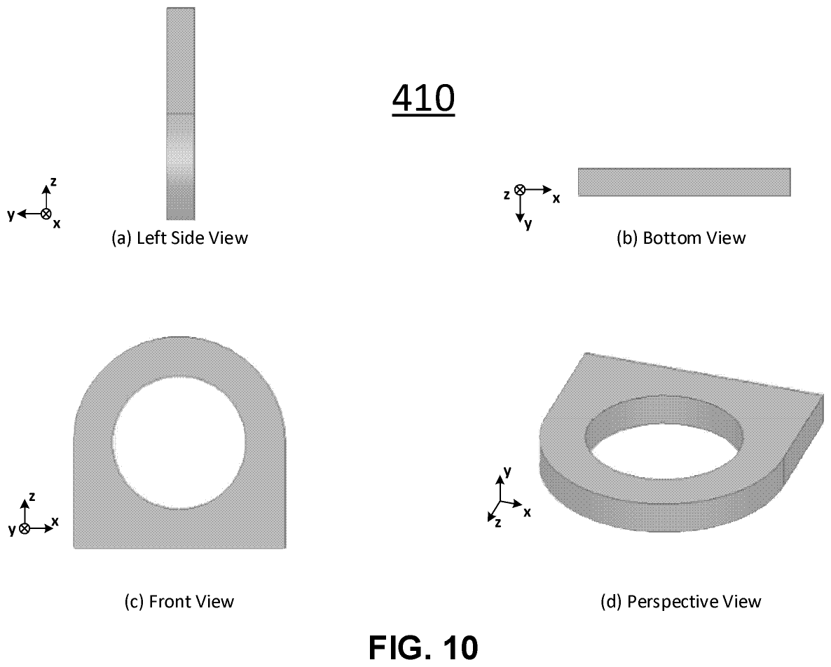

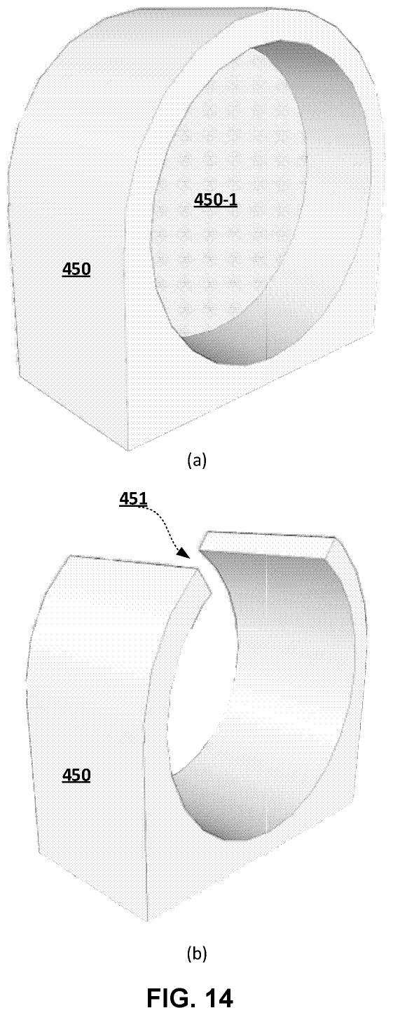

In some embodiments, the first portion 410-1 may be separated from the second portion 420-1 by at least a third portion 450-1 of the third core 450, for example, as shown in (a) of FIG. 14. As shown in (a) of FIG. 14, the third core 450 may further comprise, when compared with those shown in FIG. 4A, (a) of FIG. 5, and FIG. 10, a third portion 450-1, which may be a thin layer that separates the first portion 410-1 from the second portion 420-1. In such a case, two recesses may be formed on both sides of the third core 450, respectively, to receive, accommodate, and hold the first portion 410-1 and the second portion 420-1, respectively.

In some embodiments, the first core 410 and the second core 420 may be identical to each other. For example, each of the first core 410 and the second core 420 may be an EP type core, as shown in (b) of FIG. 5, and they can be combined to each other with the third core 450 interposed therebetween to form the inductor 400, as shown in FIG. 4A and FIG. 6A through FIG. 6C.

In some embodiments, the first portion 410-1 and the second portion 420-1 may be integrally formed, for example, as shown in (c) of FIG. 15B. In such a case, the third core 450 may be composed of two portions 450-2 and 450-3, such that they can be mounted around the first portion 410-1 and/or the second portion 420-1 separately and then adjoined to each other to form the inductor 400.

In some embodiments, the third core 450 may partially or completely surround at least a part of the first portion 410-1 and/or at least a part of the second portion 420-1. For example, as shown in (a) of FIG. 5, the third core 450 may completely surround the first portion 410-1. For another example, the third core 450 may have a shape of an open ring as shown in (b) of FIG. 14, such that the third core 450 may be mounted around the first portion 410-1 and/or second portion 420-1 via the opening 451 of the third core 450. Such a third core 450 may be particularly useful when the first portion 410-1 and the second portion 420-1 are integrally formed as shown in (c) of FIG. 15B.

In some embodiments, the first core 410, the second core 420, or the combination thereof may have a portion that partially or completely surrounds the third core 450. For example, the first core 410 may have a portion 410-2 that surrounds the third core 450, as shown in FIG. 5 and (b) of FIG. 4A. Similarly, the second core 420 may have a portion 420-2 that surrounds the third core 450.

In some embodiments, the inductor 400 may further comprise a bottom frame 460, for example, as shown in FIG. 4B. The first core 410 and the second core 420 may be supported on the bottom frame 460, and one or more terminals (e.g., 430-1, 430-2, 440-1, 440-2) of the first coil 430 and/or the second coil 440 may be exposed through the bottom frame 460. In some embodiments, the bottom frame 460 may be made of T375J material.

FIG. 6A, FIG. 6B, and FIG. 6C are diagrams illustrating operational principles of exemplary inductors 400 according to some embodiments of the present disclosure.

In some embodiments, the first coil 430 may have a first terminal 430-1 and a second terminal 440-1, and the second coil 440 may have a third terminal 440-1 and a fourth terminal 440-2. The first coil 430 and the second coil 440 may have winding directions and terminal definitions such that a magnetic field created by the first signal and a magnetic field created by the second signal may be offset to each other when the first and second signals pass through the first and second coils 430 and 440, respectively. For example, when the first signal travels through the first coil 430, it may create a magnetic field over the first core 410, for example, as indicated by the arrows ϕ₁ in FIG. 6A through FIG. 6C. Similarly, when the second signal travels through the second coil 440, it may create another magnetic field over the second core 420, for example, as indicated by the arrows ϕ₂ in FIG. 6A through FIG. 6C. In this way, the two magnetic fields may be offset to each other or even cancelled out, and the pair of signals may not be affected by the inductor 400, while the CM noise can be suppressed, as explained with reference to FIG. 1.

In some embodiments, the first terminal 430-1 may be an input terminal and the second terminal 430-2 may be an output terminal and closer to the third core 450 than the first terminal 430-1, as shown in FIG. 6A. Further, the third terminal 440-1 may be an input terminal and the fourth terminal 440-2 may be an output terminal and closer to the third core 450 than the third terminal 440-1. Furthermore, the first coil 430 may have one of a left-handed winding direction and a right-handed winding direction between the first terminal 430-1 and the second terminal 430-2, while the second coil 440 may have the same winding direction between the third terminal 440-1 and the fourth terminal 440-2 as that of the first coil 430. For example, as shown in FIG. 6A, the first signal may travel through the first coil 430 from the input terminal 430-1 to the output terminal 430-2, and the winding direction of the first coil 430 may be a right-handed winding direction. In such a case, a magnetic field ϕ₁ may be generated with a direction of down in the middle part (e.g., the first portion 410-1) and a direction of up in the edge parts (e.g., side walls of the first core 410-2). Similarly, with the second coil 440's own terminal definition and the same winding direction as that of the first coil 430, the second signal that travels through the second coil 440 from the input terminal 440-1 to the output terminal 440-2 may generate another magnetic field ϕ₂ with opposite directions to those of the magnetic field generated by the first signal. In this way, the flux of the magnetic fields ϕ₁ and ϕ₂ may be offset to each other or even cancelled out, and the pair of the signals is not impacted.

Further, by additionally providing the third core 450, some of the magnetic flux may be leaked as indicated by the arrows ϕ₁′ and ϕ₂′ shown in FIG. 6A. The leaked magnetic fields may result in a leakage inductance, which may in turn suppress some of the DM noise in the signals, especially the DM noise in a low frequency range.

In some embodiments, the first terminal 430-1 may be an output terminal and the second terminal 430-2 may be an input terminal and closer to the third core 450 than the first terminal 430-1, as shown in FIG. 6B. Further, the third terminal 440-1 may be an output terminal and the fourth terminal 440-2 may be an input terminal and closer to the third core 450 than the third terminal 440-1. Furthermore, the first coil 430 may have one of a left-handed winding direction and a right-handed winding direction between the first terminal 430-1 and the second terminal 430-2, while the second coil 440 may have the same winding direction between the third terminal 440-1 and the fourth terminal 440-2 as that of the first coil 430. With such a configuration, same or similar technical effects may be achieved by the inductor 400 shown in FIG. 6B as that shown in FIG. 6A.

In some embodiments, the first terminal 430-1 may be an input terminal and the second terminal 430-2 may be an output terminal and closer to the third core 450 than the first terminal 430-1, as shown in FIG. 6C. Further, the third terminal 440-1 may be an output terminal and the fourth terminal 440-2 may be an input terminal and closer to the third core 450 than the third terminal 440-1. Furthermore, the first coil 430 may have one of a left-handed winding direction and a right-handed winding direction between the first terminal 430-1 and the second terminal 430-2, while the second coil 440 may have the other of the left-handed winding direction and the right-handed winding direction between the third terminal 440-1 and the fourth terminal 440-2. Please note that, due to a different terminal definition than that shown in FIG. 6A and FIG. 6B, the winding direction of the second coil 440 shown in FIG. 6C is different from those shown in FIG. 6A and FIG. 6B in order to achieve same or similar technical effects. With such a configuration, same or similar technical effects may be achieved by the inductor 400 shown in FIG. 6C as those shown in FIG. 6A and FIG. 6B.

In some embodiments, the first terminal 430-1 may be an output terminal and the second terminal 430-2 may be an input terminal and closer to the third core 450 than the first terminal 430-1. Further, the third terminal 440-1 may be an input terminal and the fourth terminal 440-2 may be an output terminal and closer to the third core 450 than the third terminal 440-1. Furthermore, the first coil 430 may have one of a left-handed winding direction and a right-handed winding direction between the first terminal 430-1 and the second terminal 430-2, while the second coil 440 may have the other of the left-handed winding direction and the right-handed winding direction between the third terminal 440-1 and the fourth terminal 440-2. With such a configuration, same or similar technical effects may be achieved by the inductor 400 as those shown in FIG. 6A, FIG. 6B, and FIG. 6C.

In some embodiments, the number of turns of wire in at least one of the first and second coils 430, 440 may be 4.5 or another number as required. In some embodiments, at least one of the first and second coils 430, 440 may be made of SFT-AIW 220° C. flat copper wire. However, the present disclosure is not limited thereto. In some other embodiments, the number of turns and/or the material of the coils may be changed as required.

In some embodiments, the inductor 400 may have dimensions of (22.0 mm±0.6 mm)*(21.4 mm±0.6 mm)*(22.5 mm±0.3 mm). In some embodiments, at least one of the first and second coils 430, 440 may be made of a flat wire. In some embodiments, at least one of the first and second coils 430, 440 may be formed by a helical winding method. However, the present disclosure is not limited thereto. In some other embodiments, another product specification may be used.

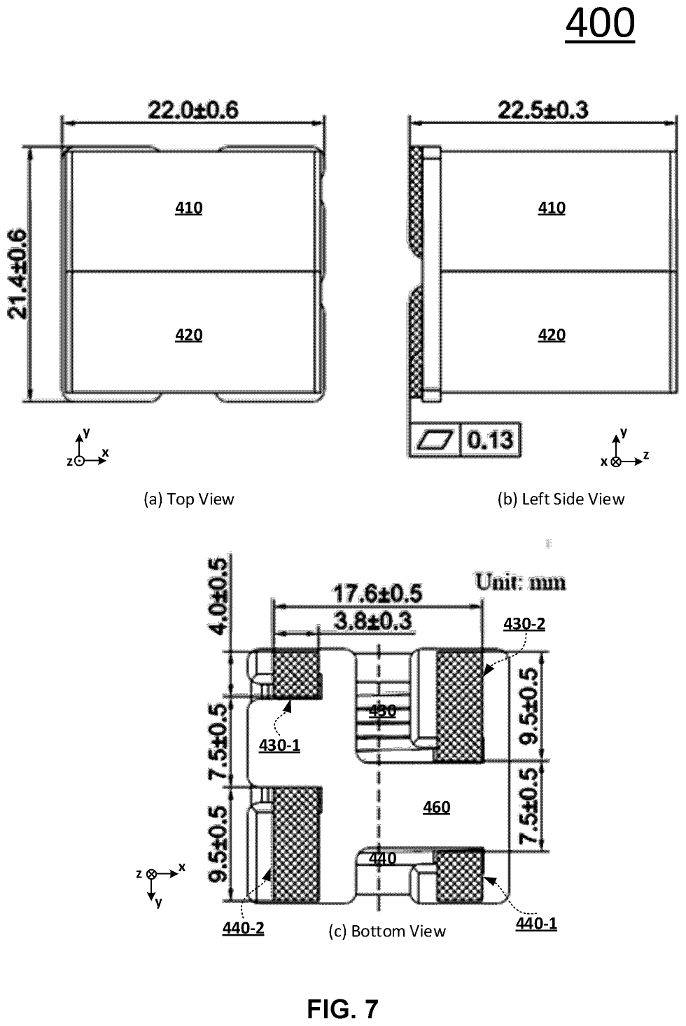

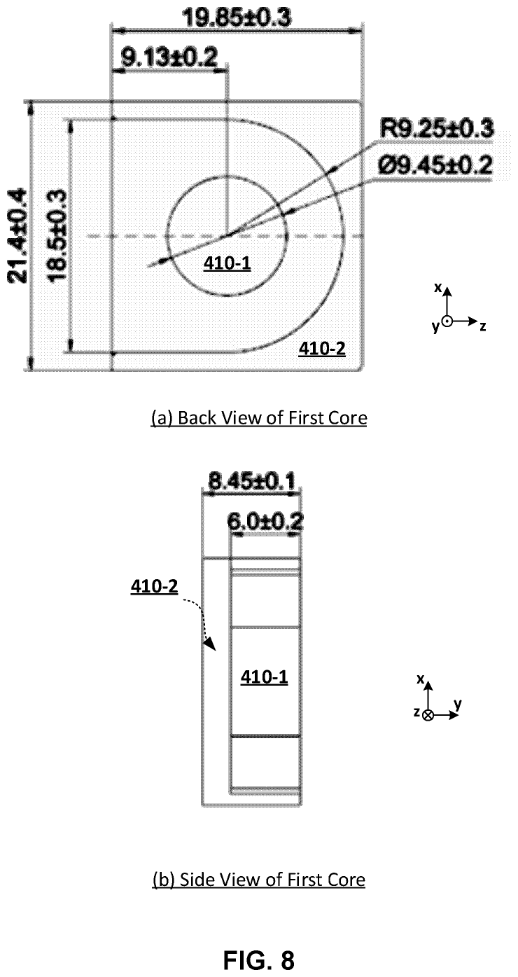

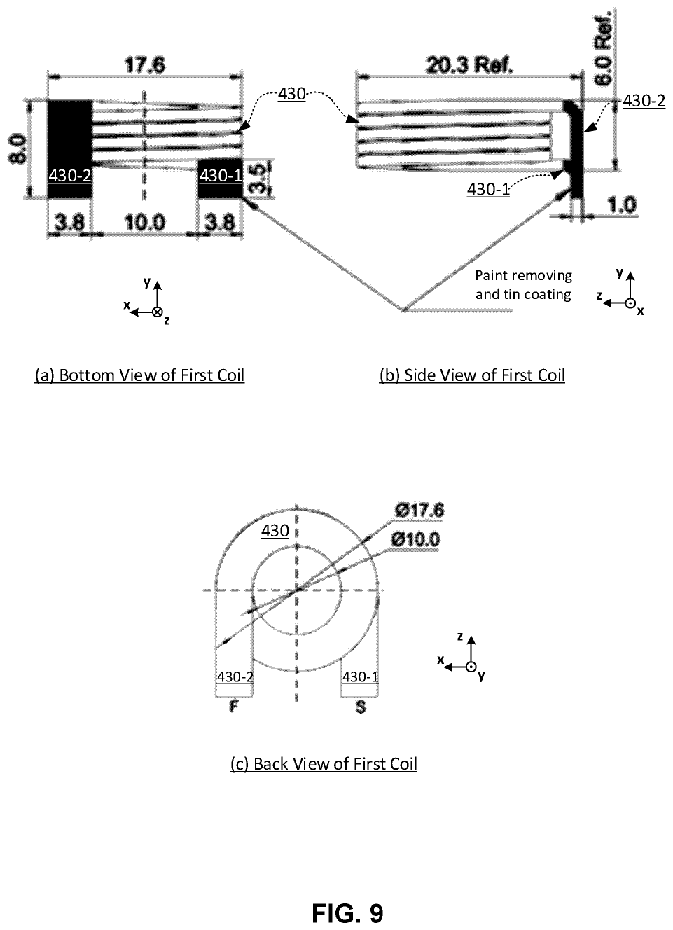

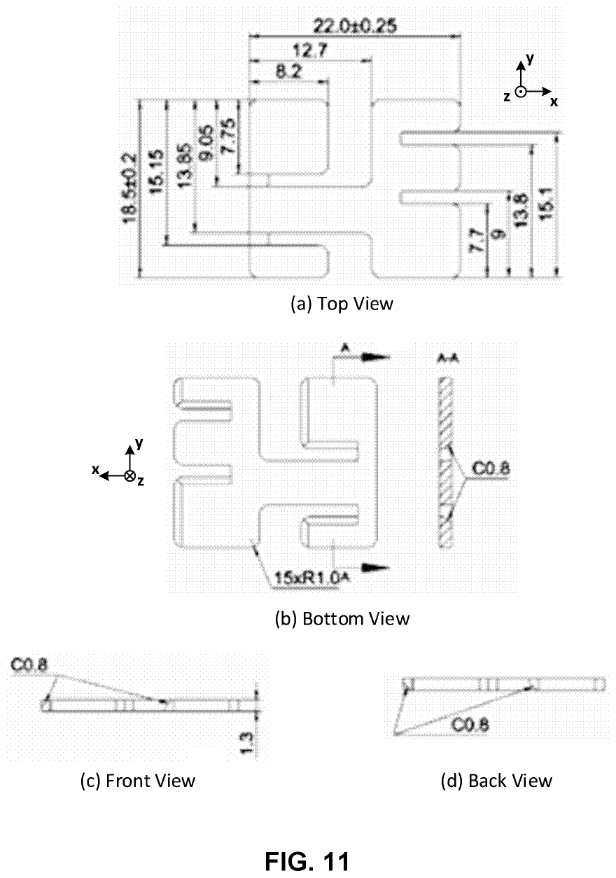

FIG. 7 shows product specifications of an exemplary inductor according to an embodiment of the present disclosure. FIG. 8 shows product specifications of a core of an exemplary inductor according to an embodiment of the present disclosure. FIG. 9 shows product specifications of a coil of an exemplary inductor according to an embodiment of the present disclosure. FIG. 10 shows (a) a left side view, (b) a bottom view, (c) a front view, and (d) a perspective view of a middle core of an exemplary inductor according to an embodiment of the present disclosure. FIG. 11 shows product specifications of a bottom frame of an exemplary inductor according to an embodiment of the present disclosure. The inductors shown in FIG. 7 through FIG. 11 may correspond to the inductor 400 above, and therefore they can be referred to as the inductor 400 as well. However, the present disclosure is not limited thereto since FIG. 7 through FIG. 11 merely show some exemplary details of the inductor 400.

As shown in FIG. 7, the inductor 400 may have a same size and pin pattern as those of a conventional CMC, and therefore the inductor 400 may be used to replace the conventional CMC, such that efforts to create new CAD file for PCB layout may be omitted. Further, the inductor 400 may replace the conventional CMC flexibly during the debug process, and it may provide designers with multiple choices for EMC debugging.

FIG. 8 shows some detailed data of the first core 410. Since the second core 420 may have a same shape and a same size as those of the first core 410, FIG. 8 is also applicable to the second core 420. FIG. 9 shows some detailed data of the first coil 430. Since the second coil 440 may have a same shape and a same size as those of the first coil 430, FIG. 9 is also applicable to the second coil 440.

Although FIG. 10 and FIG. 11 show specific designs of the third core 450 and the bottom frame 460, the present disclosure is not limited thereto. In some other embodiments, the third core 450 may have a different configuration than that shown in FIG. 10, for example, the third core shown in FIG. 14 or the third core 450-2/450-3 shown in (c) of FIG. 15B. Further, the bottom frame 460 may have a different shape and/or a different size as long as the terminals may be exposed and the components may be supported thereon.

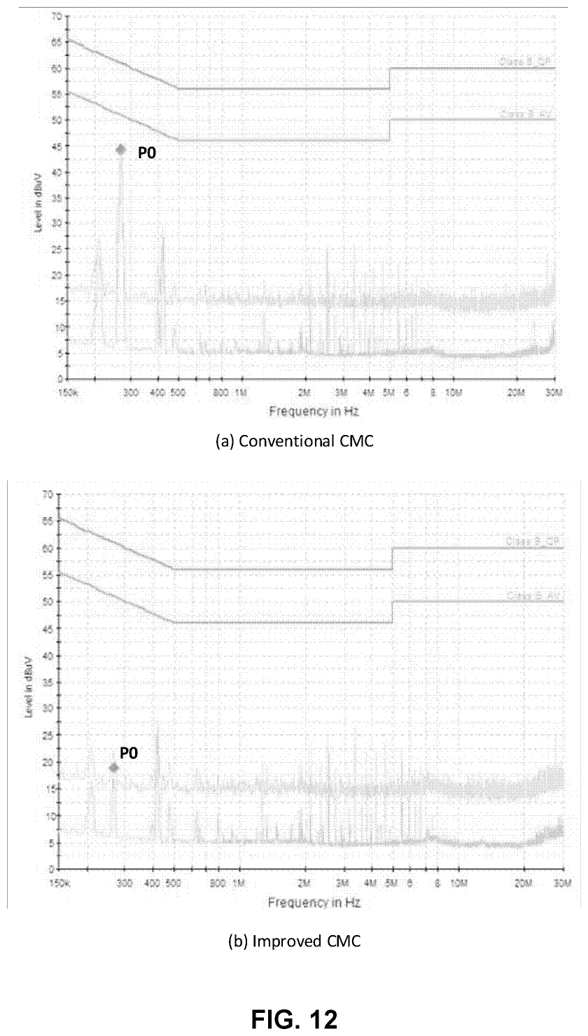

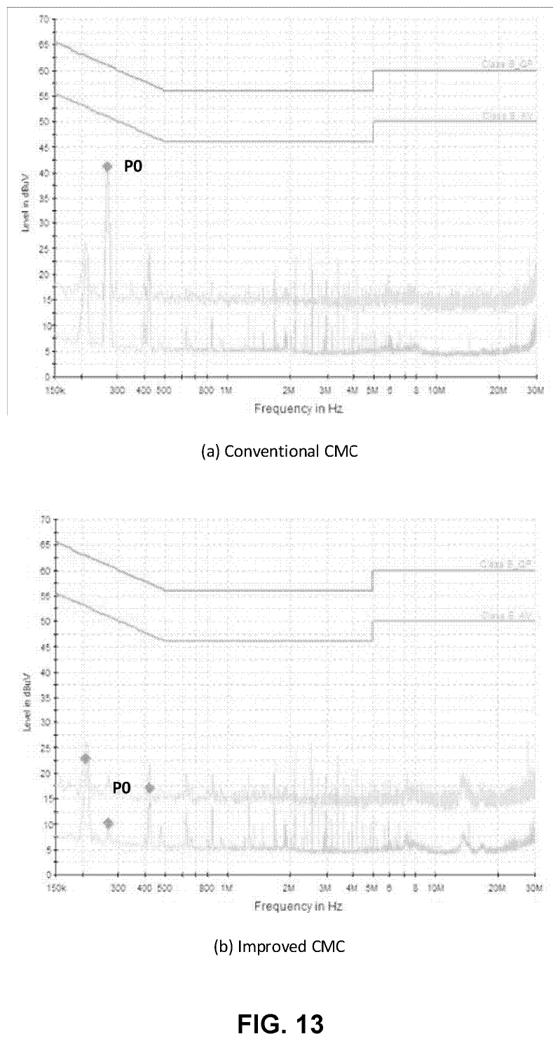

FIG. 12 and FIG. 13 show comparisons between simulation results for a conventional CMC and an inductor according to an embodiment of the present disclosure. As indicated by the points P0 in these two figures, the noise may be significantly suppressed, especially in a low frequency range. The comparisons in FIG. 12 and FIG. 13 show that the inductor 400 (or improved CMC) may deduct the low frequency noise a lot than the conventional CMC. For L line shown in FIG. 12, it may reduce the noise level from 44.4 dbuV to 19.1 dbuV at 267 KHz frequency. For N line shown in FIG. 13, it may reduce the noise level from 41.2 dbuV to 10.2 dbuV at 267 KHz frequency. The improvement at low frequency (under 1 MHZ) is obvious. For the frequency higher than or equal to 1 MHZ, the EMC performance of the inductor 400 remains the same as the conventional CMC. This can be expected since the CM inductance is almost same for both the conventional CMC and the inductor 400 (the improved CMC).

Further, some ambient conditions and electrical characteristics of the inductor 400 and the conventional CMC are provided below.

Ambient condition for the inductor or the improved CMC:

| Parameter | Value | | Condition |
|---|---|---|---|
| Operating | −40° C.~+125° C. | | Self-temperature |
| Ambient | | | rise included |
| Storage | Relative humidity | 5%~ | Good ventilation, dry |
| Ambient | | 85% | ground and no corrosive |
| | Temperature | −10° C.~ | gas are in the warehouse |
| | | +85° C. | |

Electrical characteristics for the inductor or the improved CMC (25°
C. ± 5° C.; unless otherwise noted):

| Parameter | Terminal | Value | Condition |
|---|---|---|---|
| CM Inductance | 1-2 = 4-3 | 225 μH ± 45% | 100 kHz, 0.1 Vᵣₘₛ |
| (L_{CM}) | | | |
| DC Resistance | 1-2 = 4-3 | 1.5 mΩ Max. | / |
| (DCR) | | | |
| DM Inductance | 1-2 | 2.5 μH ± 20% | 100 kHz, 0.1 Vᵣₘₛ |
| (L_{DM}) | | | (short pin 3, 4) |
| Turn ratio | (1-2):(4-3) | 1 ± 2% | 100 kHz, 1.0 Vᵣₘₛ |
| Dielectric strength | 1&2-4&3 | 200 V DC | 6 s Leak current is 1 |
| | | | mA Max. |
| Temperature rise | 1-2&4-3 | 28 A | DC current at 25° C. |
| current (Iᵣₘₛ₁) | | | that causes an |
| | | | temperature rise of |
| | | | 25° C. approx. |
| Temperature rise | 1-2&4-3 | 45 A | DC current at 25° C. |
| current (Iᵣₘₛ₂) | | | that causes an |
| | | | temperature rise of |
| | | | 65° C. approx. |

Ambient condition for the conventional CMC:

| Parameter | Value | | Condition |
|---|---|---|---|
| Operating | −40° C.~+125° C. | | Self-temperature rise included |
| Ambient | | | |
| Storage | Relative | 5%~ | Good ventilation, dry |
| Ambient | humidity | 85% | ground and no |
| | Temperature | −10° C.~ | corrosive gas are |
| | | +85° C. | in the warehouse |

Electrical characteristics for the conventional CMC (25°
C. ± 5° C.; unless otherwise noted):

| Parameter | Terminal | Value | Condition |
|---|---|---|---|
| Inductance (L₀) | 1-2 = 4-3 | 225 μH ± 45% | 100 kHz, 0.1 Vᵣₘₛ |
| DC Resistance | 1-2 = 4-3 | 1.5 mΩ Max. | / |
| (DCR) | | | |
| Turn ratio | (1-2):(4-3) | 1 ± 2% | 100 kHz, 1.0 Vᵣₘₛ |
| Dielectric strength | 1&2-4&3 | 200 V DC | 6 s Leak current is 1 |
| | | | mA Max. |
| Rated current | 1-2, 4-3 | 45 A | About 65° C. |
| | | | temperature rise |

In other words, an advantage of the improved CMC or inductor 400 is that it may improve the system's capability of suppressing low frequency noise a lot with almost same component size when compared with the conventional CMC. Since the low frequency noise is much lower than before in a radio system, for example that shown in FIG. 2, then this advantage may be utilized to achieve a further benefit. For example, several DM inductors may be removed from the radio system. In other words, the occupied space and costs for these DM inductors may be saved.

For example, in a specific implementation of the radio system with the inductor 400, some components may be saved, and their occupied space and costs are listed as follows:

| ITEM | REG7245503/100 | REG7245990/68 | REG7246161/1B | Total |
|---|---|---|---|---|
| Number | 2 | 1 | 1 | 4 |
| saved | | | | |
| Cost | 1.72 SEK* | 7.92 SEK | 2.66 SEK | ~14 SEK |
| Occupied | 6.7 mm * | 13 mm * | 10.8 mm * | ~370 mm² |
| area | 6.2 mm | 14.5 mm | 9.2 mm | or ~2417 |
| height | 4.8 mm | 6.5 mm | 8 mm | mm³ |

*SEK indicates Swedish Krona

With such a significant cost down, the lightning test is still not affected, and the EMC requirements can still be met.

The disclosure has been described with reference to embodiments and drawings. It should be understood that various modifications, alternations and additions can be made by those skilled in the art without departing from the spirits and scope of the disclosure. Therefore, the scope of the disclosure is not limited to the above particular embodiments but only defined by the claims as attached and equivalents thereof.

### Abbreviation Explanation

CM Common Mode
CMC Common Mode Choke
DM Differential Mode
DPA Destructive Physical Analysis
EMC Electromagnetic Compatibility
EMI Electromagnetic Interference
MOV Metal Oxide Varistors
SPD Surge Protection Device

1. An inductor for suppressing noise in a pair of a first signal and a second signal, the inductor comprising:
a first core;
a second core adjoined to the first core;
a first coil wound around at least a first portion of the first core;
a second coil wound around at least a second portion of the second core; and
a third core adjoined to the first core and/or the second core and disposed between the first coil and the second coil,
wherein the inductor is operable to attenuate both common mode (CM) noise and differential mode (DM) noise in the first signal and the second signal that pass through the first coil and the second coil, respectively.

2. The inductor of claim 1, wherein the third core is made of a material having a lower magnetic permeability than that of the first core and/or the second core and a higher magnetic permeability than that of air.

3. The inductor of claim 1, wherein the first core and/or the second core are made of R10K material,
wherein the third core is made of PC95 material.

4. The inductor of claim 1, wherein at least one of the first portion and the second portion has a shape of cylinder.

5. The inductor of claim 4, wherein the first portion is adjoined to the second portion by their end faces of the cylinders.

6. The inductor of claim 1, wherein the first portion is separated from the second portion by an air gap.

7. The inductor of claim 1, wherein the first portion is separated from the second portion by at least a third portion of the third core.

8. The inductor of claim 1, wherein the first core and the second core are identical to each other.

9. The inductor of claim 1, wherein the first portion and the second portion are integrally formed.

10. The inductor of claim 1, wherein the third core partially or completely surrounds at least a part of the first portion and/or at least a part of the second portion.

11. The inductor of claim 1, wherein at least one of the first core and the second core is an EP type core.

12. The inductor of claim 1, wherein the first core, the second core, or the combination thereof has a portion surrounds the third core.

13. The inductor of claim 1, further comprising:
a bottom frame on which the first core and the second core are supported, and through which one or more terminals of the first coil and/or the second coil are exposed.

14. The inductor of claim 1, wherein the first coil has a first terminal and a second terminal, and the second coil has a third terminal and a fourth terminal,
wherein the first coil and the second coil have winding directions and terminal definitions such that a magnetic field created by the first signal and a magnetic field created by the second signal are offset to each other when the first and second signals pass through the first and second coils, respectively.

15. The inductor of claim 14, wherein the first terminal is an input terminal and the second terminal is an output terminal and closer to the third core than the first terminal,
wherein the third terminal is an input terminal and the fourth terminal is an output terminal and closer to the third core than the third terminal,
wherein the first coil has one of a left-handed winding direction and a right-handed winding direction between the first terminal and the second terminal,
wherein the second coil has the same winding direction between the third terminal and the fourth terminal as that of the first coil.

16. The inductor of claim 14, wherein the first terminal is an output terminal and the second terminal is an input terminal and closer to the third core than the first terminal,
wherein the third terminal is an output terminal and the fourth terminal is an input terminal and closer to the third core than the third terminal,
wherein the first coil has one of a left-handed winding direction and a right-handed winding direction between the first terminal and the second terminal,
wherein the second coil has the same winding direction between the third terminal and the fourth terminal as that of the first coil.

17. The inductor of claim 14, wherein the first terminal is an input terminal and the second terminal is an output terminal and closer to the third core than the first terminal,
wherein the third terminal is an output terminal and the fourth terminal is an input terminal and closer to the third core than the third terminal,
wherein the first coil has one of a left-handed winding direction and a right-handed winding direction between the first terminal and the second terminal,
wherein the second coil has the other of the left-handed winding direction and the right-handed winding direction between the third terminal and the fourth terminal.

18. The inductor of claim 14, wherein the first terminal is an output terminal and the second terminal is an input terminal and closer to the third core than the first terminal,
wherein the third terminal is an input terminal and the fourth terminal is an output terminal and closer to the third core than the third terminal,
wherein the first coil has one of a left-handed winding direction and a right-handed winding direction between the first terminal and the second terminal,
wherein the second coil has the other of the left-handed winding direction and the right-handed winding direction between the third terminal and the fourth terminal.

19. The inductor of claim 1, wherein the number of turns of wire in at least one of the first and second coils is 4.5.

20. The inductor of claim 1, wherein the inductor has a dimension of.

21-22. (canceled)
